(19) United States
(12) Patent Application Publication
(10) Pub. No.: US 2009/0038962 A1
(43) Pub. Date: Feb. 12, 2009

(54) FLUE GAS ANALYSER

(75) Inventors: John Robert SAFFELL, Cambridge (GB); Darryl Hirst DAWSON, Essex (GB)

Correspondence Address: NIXON & VANDERHYE, PC, 901 NORTH GLEBE ROAD, 11TH FLOOR, ARLINGTON, VA, 22203, US

(73) Assignee: ALPHASENSE LIMITED, Essex (GB)

(21) Appl. No.: 12/182,573

(22) Filed: Jul. 30, 2008

(30) Foreign Application Priority Data
Jul. 30, 2007 (GB) 0714788.7

(51) Int. Cl. G01N 27/26; F22B 7/16

(52) U.S. Cl. 205/785.5; 204/431; 204/415; 122/135.1

(57) ABSTRACT

A fuel gas analyzer for measuring the concentration of oxygen in fuel gas, comprising an electrochemical oxygen sensor and water vapor removing means for reducing the relative humidity of received gas and/or nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor,

### FIELD OF THE INVENTION

The present invention relates to the field of fuel gas analyzers for measuring the concentration of oxygen in fuel gas.

### BACKGROUND TO THE INVENTION

Electrochemical oxygen sensors are in common use at the present time for measuring the concentration of oxygen in gas samples. Electrochemical oxygen sensors are used in fuel gas analyzers for measuring the concentration of oxygen in fuel gas. fuel gas is the combustion product which exits through the fuels of industrial or domestic boilers for heating water or generating power which burn fossil fuels, such as oil, gas and coal, or other plant derived fuels, such as wood or other biofuels.

It has been known for some time that electrochemical gas sensors sometimes fail when measuring the concentration of oxygen in fuel gas emitted by some boiler installations. This failure usually occurs within a few days to months of installation. Sometimes the failure is irreversible; sometimes the failure is reversible and the sensors recover after 1 to 3 days without exposure to fuel gas.

The failure of electrochemical oxygen sensors in some boiler installations has presented a serious problem for the gas sensing industry. The reason for the failures has been a mystery. Tests in which electrochemical oxygen sensors are exposed to the individual chemical species which make up typical fuel gas do not reproduce the failures.

The present invention aims to provide fuel gas analyzers comprising electrochemical oxygen sensors, which are suitable for prolonged use in installations where conventional fuel gas analyzers comprising electrochemical oxygen sensors fail.

Within this specification and the appended claims, the term nitrogen dioxide includes its dimmer dinitrogen tetroxide with which nitrogen dioxide is in equilibrium in the gaseous phase.

### SUMMARY OF THE INVENTION

According to a first aspect of the present invention there is provided a fuel gas analyzer for measuring the concentration of oxygen in fuel gas, comprising an inlet for receiving gas for analysis, an electrochemical oxygen sensor, and water vapor removing means for reducing the relative humidity of received gas and/or nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor.

We have discovered that, surprisingly, electrochemical oxygen sensors fail in the presence of a combination of both nitrogen dioxide and a sufficiently high concentration of water vapor, typically at least 80% relative humidity. Accordingly, by providing a fuel gas analyzer including an electrochemical oxygen sensor, and water vapor removing means and/or nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor, we have provided a fuel gas analyzer comprising an electrochemical oxygen sensor which is suitable for prolonged use in installations where conventional fuel gas analyzers comprising electrochemical oxygen sensors fail.

The fuel gas analyzer may comprise water vapor removing means for removing water vapor from received gas, such as a dehumidifying element. Suitable dehumidifying elements include water absorbing filters and water permeable membranes, such as NAFION brand sulfonated tetrafluorethylene copolymer, (NAFION is a trade mark of E. I. du Pont de Nemours and Company). Water vapor removing means need not remove the majority of water vapor. The water vapor removing means need only remove a proportion of water vapor from the received fuel gas sufficient to mitigate damage to the electrochemical oxygen sensor in the presence of both nitrogen dioxide and a high concentration of water vapor.

Preferably, the fuel gas analyzer comprises nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor. The nitrogen-containing gas removing means should remove the substantial majority of the gaseous species.

By gaseous species formed from nitrogen dioxide in the presence of sufficient water vapor, which would otherwise lead to damage of the electrochemical oxygen sensor, we refer to gaseous species formed from nitrogen dioxide in the presence of sufficient water vapor (typically at least 80%, and preferably at least 90% relative humidity) in sufficient quantities to damage the electrochemical oxygen sensor if they were not removed which would not be formed from nitrogen monoxide (e.g. in the presence of 1,000 ppm nitrogen monoxide at 90% relative humidity) in the presence of the same amount of water vapor in sufficient quantities to damage the electrochemical oxygen sensor if they were not removed. The nitrogen-containing-gas removing means may remove a gaseous species which would not in itself damage the electrochemical oxygen sensor but which is part of a series of chemical reactions leading to the formation of a species which would otherwise damage the electrochemical oxygen sensor.

The gaseous species formed from nitrogen dioxide in the presence of sufficient water vapor, which would otherwise lead to damage of the electrochemical oxygen sensor may be one or more of nitric acid (HNO₃), nitrous acid (HNO₂) and dinitrogen pentoxide (N₂O₅). Accordingly, the nitrogen-containing-gas removing means may be 37 nitric acid removing means for removing nitric acid from received gas. The nitrogen-containing-gas containing-gas removing means may be nitrous acid removing means for removing nitrous acid from received gas. The nitrogen-containing-gas removing means may be dinitrogen pentoxide removing means for removing nitrogen pentoxide from received gas.

The nitrogen-containing-gas removing means may be means for removing nitrogen dioxide from received gas. The nitrogen-containing-gas removing means may remove nitrogen monoxide from received gas, as well as nitrogen dioxide. Alternatively, the nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor, but not remove nitrogen monoxide.

The nitrogen-containing-gas removing means may remove a range of acid gases including nitrogen dioxide and nitrogen monoxide from received gas. The nitrogen-containing-gas removing means may remove a range of acid gases including nitrogen dioxide, nitrogen monoxide and sulfur dioxide from received gas. Although we have shown that the removal of nitrogen monoxide and/or sulfur dioxide is not required, it can be more cost effective in some circumstances to use a nitrogen-containing-gas removing means which removes a range of acid gases from received gas in preference to a nitrogen-containing-gas removing means which removes only a specific gaseous species from received gas.

The nitrogen-containing-gas removing means may be a filter. The filter may be a filter which removes nitrogen dioxide from received gas. The filter may be a filter which removes a plurality of acid gases including nitrogen dioxide and nitrogen monoxide from received gas.

The nitrogen-containing-gas removing means may be a catalyst for converting one or more of nitrogen dioxide, or another gaseous species formed from nitrogen dioxide in the presence of sufficient water vapor, which would otherwise lead to damage of the electrochemical oxygen sensor, to a gaseous species which would not damage the electrochemical sensor.

The nitrogen-containing-gas removing means may comprise a permanganate salt, such as potassium permanganate. The use of nitrogen-containing-gas removing means which, like potassium permanganate, changes visual properties (e.g. color) when it removes gas provides a visual indicator when the nitrogen-containing-gas removing means is coming towards the end of its operational life.

The nitrogen-containing-gas removing means may comprise a nitrogen-containing-gas removing filter material, such as a sheet of nitrogen dioxide adsorbing activated carbon. The nitrogen-containing gas removing filter material may be configured to provide a tortuous path for gas to diffuse through the filter material. This enables a high surface area of filter material to be provided in a compact volume. For example, the nitrogen-containing-gas removing means may comprise a plurality of sheets of nitrogen dioxide adsorbing activated carbon spaced apart by gas impermeable members configured to provide a tortuous path for received gas to diffuse through the sheets of nitrogen dioxide adsorbing activated carbon.

The electrochemical oxygen sensor typically comprises a cathode which is operable to reduce oxygen. Typically, the electrochemical oxygen sensor comprises a mass flow control member which restricts diffusion of gas to the cathode. Typically, the mass flow control member is selected such that the reduction of oxygen at the cathode is mass flow limited. Accordingly, the electrochemical oxygen sensor is preferably a mass flow controlled electrochemical oxygen sensor. One skilled in the art will appreciate that partial pressure electrochemical oxygen sensors are not mass flow controlled electrochemical oxygen sensors.

The mass flow control member is preferably a narrow tube, such as a narrow tube which extends through a block of solid material. The narrow tube typically has a diameter of 100 microns or less. The water removing means or nitrogen-containing-gas removing means could be gas permeable and function as the mass flow control member.

The mass flow control member is typically made from a plastics material, preferably a thermoplastics material, such as acrylonitrile butadiene styrene (ABS), or polycarbonate.

The nitrogen-containing-gas removing means and/or water vapor removing means may be located within the mass flow control member. The nitrogen-containing-gas removing means and/or water vapor removing means may be located intermediate the inlet and the mass flow control member. These arrangements can reduce damage to the mass flow control member in the presence of both nitrogen dioxide and a high concentration of water vapor, which is useful in embodiments where the mass flow control member is susceptible to damage in the presence of both nitrogen dioxide and a high concentration of water vapor. By “damage” we include blockage of the mass flow control member. The nitrogen-containing-gas removing means and/or water vapor removing means may be gas permeable and function as the mass flow control member.

The nitrogen-containing-gas removing means and/or water vapor removing means are typically located intermediate the inlet and the cathode. The nitrogen-containing-gas removing means and/or water vapor removing means may be in gaseous communication with a gas pathway which conducts analyte gas from the inlet to the cathode. The inlet may be a surface of the nitrogen-containing-gas removing means and/or water vapor removing means.

Typically, a gas space is provided between the mass flow control member and the cathode. The gas space may be arranged to facilitate diffusion of oxygen from the mass flow control member across the whole surface of the cathode. The nitrogen-containing-gas removing means and/or water vapor removing means may be located within the gas space. The cathode is typically covered by a gas permeable liquid impermeable barrier, such as a layer of hydrophobic microporous polytetralfluoroethylene (PTFE), which facilitates the conduction of oxygen to the cathode while retaining electrolyte. In this case, the gas space is typically intermediate the mass flow control member and the gas permeable liquid impermeable barrier. The gas permeable liquid impermeable barrier may be susceptible to damage in the presence of both nitrogen dioxide and a sufficiently high concentration of water vapor.

The fuel gas analyzer may further comprise a nitrogen oxide sensor which is operable to measure the concentration of a specific nitrogen oxide, such as nitrogen monoxide, or nitrogen dioxide, or the concentration of a range of nitrogen oxides (referred to in the art as a NOₓ sensor). Where the fuel gas analyzer comprises both a nitrogen oxide sensor which is operable to measure nitrogen dioxide and nitrogen-containing-gas removing means, the nitrogen oxide sensor is located intermediate the inlet and the nitrogen-containing-gas removing means or in gaseous communication with the inlet other than through the nitrogen-containing-gas removing means. A nitrogen dioxide sensor which removes the majority of nitrogen dioxide which contacts an inlet of the nitrogen dioxide sensor may function as the nitrogen-containing-gas removing means.

The fuel gas analyzer is typically operable to measure carbon monoxide concentration as well as oxygen concentration. Typically, the fuel gas analyzer includes carbon monoxide sensing apparatus, in addition to the oxygen sensing apparatus. Typically, both the carbon monoxide sensing apparatus and the oxygen sensing apparatus are in gaseous communication with the same gas inlet of the fuel gas analyzer. Preferably, the fuel gas analyzer calculates carbon dioxide concentration from the dilution of oxygen by carbon dioxide. The fuel gas analyzer may also measure the concentration of other gases, for example sulfur and nitrogen oxide concentrations.

The electrochemical oxygen sensor is preferably based on the oxidation of anode material. For example, the electrochemical oxygen sensor may comprise a lead anode.

The invention extends in a second aspect to a fuel in gaseous communication with a fuel gas analyzer according to a first aspect of the present invention. Preferably, the fuel conducts fuel gas which, were it not for the presence of the nitrogen-containing-gas removing means and/or water vapor removing means, would cause the fuel gas analyzer to be damaged.

Preferably, the fuel conducts fuel gas which, were it not for the presence of gas removing means and/or water vapor removing means, would reduce the operational lifetime of the fuel gas analyzer by at least a factor of ten.

The gas within the fuel typically comprises water vapor with a relative humidity of at least 80%, preferably at least 90% and more preferably at least 95%. The gas within the fuel typically comprises nitrogen dioxide at a concentration of at least 5 parts per million (ppm). By at least 5 ppm, we mean that for each million gas molecules, at least 5 are nitrogen dioxide. The invention also extends to a condensing boiler including a said fuel.

The nitrogen-containing-gas removing means and/or water vapor removing means may be integrated with or separate to the electrochemical oxygen sensor.

The invention extends in a third aspect to the use of a fuel gas analyzer according to a first aspect of the present invention to measure the concentration of oxygen in a fuel gas which, were it not for the presence of the nitrogen-containing-gas removing means and/or water vapor removing means, would cause the fuel gas analyzer to be damaged.

Preferably, were it not for the presence of the nitrogen-containing-gas removing means and/or water vapor removing means, the fuel gas would reduce the operational lifetime of the fuel gas analyzer by at least a factor of ten.

The fuel gas typically comprises water vapor with a relative humidity of at least 80%, preferably at least 90% and more preferably at least 95%. The fuel gas typically comprises nitrogen dioxide at a concentration of at least 5 ppm.

According to a fourth aspect of the present invention there is provided a method of measuring the concentration of oxygen in a received fuel gas comprising nitrogen dioxide and water vapor using an electrochemical oxygen sensor, comprising providing, intermediate an inlet from which the received fuel gas is received and a component of the electrochemical oxygen sensor which can be damaged in the presence of nitrogen dioxide and sufficient water vapor, water vapor removing means for reducing the relative humidity of received gas and/or nitrogen-containing-gas removing means for removing from received gas one or more gaseous species comprising nitrogen and oxygen which are either nitrogen dioxide, or formed from nitrogen dioxide in the presence of sufficient water vapor, which would damage the component of the electrochemical oxygen sensor if they were not removed. The electrochemical oxygen sensor is typically part of a fuel gas analyzer. Optional features of the fuel gas analyzer, electrochemical oxygen sensor, fuel gas, nitrogen-containing-gas removing means and/or water vapor removing means correspond to those discussed above in relation to the first three aspects.

According to a fifth aspect of the present invention there is provided a method of developing a fuel gas analyzer which has an improved operational lifetime in the presence of nitrogen dioxide and water vapor with a relative humidity of at least 80% (preferably at least 90%, or at least 95%), comprising comparing the operational lifetime of a fuel gas analyzer including water vapor removing means for reducing the relative humidity of received gas and/or nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor and a fuel gas analyzer lacking said nitrogen-containing-gas and/or water vapor removing means in a gas sample comprising at least 5 ppm of nitrogen dioxide (preferably, at least 100 ppm of nitrogen dioxide) and having a relative humidity of at least 80% (preferably at least 90%, or at least 95%).

According to a sixth aspect of the present invention there is provided a method of developing a fuel gas analyzer which has an improved operational lifetime in the presence of nitrogen dioxide and a high concentration of water vapor comprising comparing the operational lifetime of a first fuel gas analyzer and a second fuel gas analyzer including at least one part which is made from a different material to a corresponding part in the first fuel gas analyzer in the presence of gas samples comprising at least 5 ppm of nitrogen dioxide (preferably, at least 100 ppm of nitrogen dioxide) and having a relative humidity of at least 80% (preferably 90% and more preferably at least 95%).

According to a seventh aspect of the present invention there is provided a method of monitoring the concentration of oxygen in a fuel comprising measuring the relative humidity of gas within the fuel and, if the relative humidity exceeds a predetermined amount (e.g. 80%, 90% or 95%) bringing a fuel gas analyzer according to the first aspect of the present invention into gaseous communication with the gas within the fuel to monitor the concentration of oxygen within the fuel.

It may be desirable to select a fuel gas analyzer according to the first aspect of the present invention irrespective of whether nitrogen dioxide is present in fuel gas in a concentration in excess of a predetermined amount (e.g. 5 ppm) because nitrogen dioxide may only be produced intermittently or may be produced in the future.

According to an eighth aspect of the present invention there is provided a method of monitoring the concentration of oxygen in a fuel comprising measuring the relative humidity of gas within the fuel and the concentration of nitrogen dioxide in the gas within the fuel and, if the relative humidity exceeds a predetermined amount (e.g. 80%, 90% or 95%) and the concentration of nitrogen dioxide exceeds a predetermined amount, bringing a fuel gas analyzer according to the first aspect of the present invention into gaseous communication with gas within the fuel to monitor the concentration of oxygen within the fuel.

### DESCRIPTION OF THE DRAWINGS

An example embodiment of the present invention will now be illustrated with reference to the following Figures in which:

FIG. 1 is a schematic diagram of oxygen sensing apparatus according to the present invention, within a fuel gas analyzer;

FIG. 2 is a graph of the output current with time from eight electrochemical oxygen sensors in atmospheric air, with the addition of 1,000 ppm nitrogen dioxide and water vapor to 90% relative humidity;

FIG. 3 is a graph of the output current with time from eight electrochemical oxygen sensors in atmospheric air, with the addition of 100 ppm nitrogen dioxide and water vapor to 98% relative humidity;

FIG. 4 is a graph of the output current with time from eight electrochemical oxygen sensors in atmospheric air, with the addition of 1,000 ppm nitric oxide and water vapor to 90% relative humidity;

FIG. 5 is a graph of the output current with time from eight electrochemical oxygen sensors in atmospheric air, with the addition of 1,000 ppm sulfur dioxide and water vapor to 90% relative humidity;

FIG. 6 is a graph of the output current with time from eight electrochemical oxygen sensors exposed to dry atmospheric air including 1,000 ppm nitric oxide for 17 hours, followed by atmospheric air including 1,000 ppm nitric oxide and water vapor to a relative humidity of 90%;

FIG. 7 is a graph of the output current with time from eight oxygen sensors exposed to gas prepared from atmospheric air, with the addition of 1,000 ppm nitrogen dioxide and water vapor to 95% relative humidity, which was filtered through a Purafil brand filter; and

FIG. 8 illustrates an alternative filter for the oxygen sensing apparatus of FIG. 1.

### DETAILED DESCRIPTION OF AN EXAMPLE EMBODIMENT

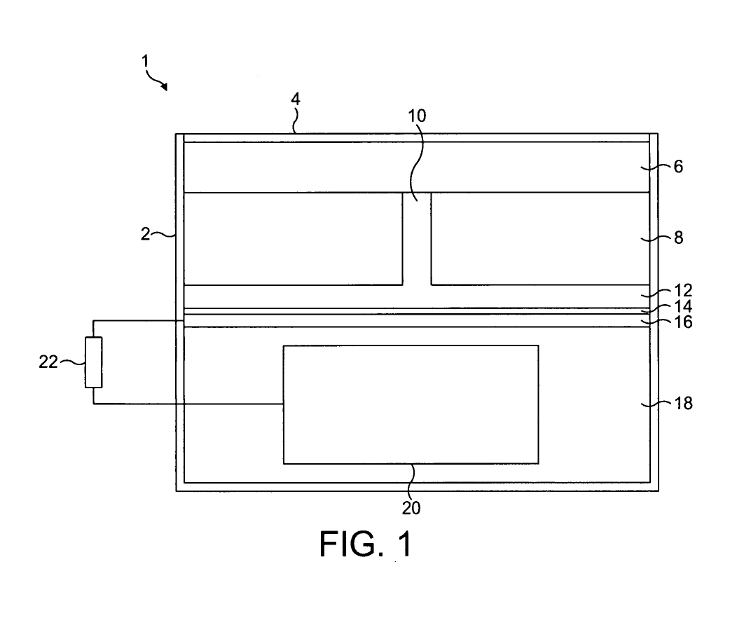

FIG. 1 illustrates oxygen sensing apparatus shown generally as 1, within a fuel gas analyzer. The fuel gas analyzer also includes carbon monoxide sensing apparatus for measuring the concentration of carbon monoxide and optionally other gas sensing apparatus for measuring additional gases. The oxygen sensing apparatus includes a housing 2 and an inlet 4 defined by holes through which a gas sample can penetrate the housing. Crystals of potassium permanganate 6 (functioning as nitrogen-containing-gas removing means) are located in a chamber intermediate the inlet and a mass flow control member 8 which takes the form of a block of ABS through the middle of which a narrow (<100 micron diameter) capillary tube 10 extends. The opposite end of the capillary tube opens into a gas space 12 bounded by the mass flow control member and a hydrophobic PTFE membrane 14, which functions as liquid permeable electrolyte retaining means. The gas space typically has a depth of only a few microns to minimise its volume. The hydrophobic PTFE membrane supports a catalyst 16 in the form of a cake of platinum, graphite and binder particles, which functions as the cathode. Gas permeates the catalyst cake through the hydrophobic PTFE membrane and hydrophobic binder particles. Electrolyte permeates the catalyst cake through the gaps between particles forming a three phase interface between analyte gas, electrolyte and catalyst within the cake.

The cathode is in gaseous communication with the gas space through the hydrophobic PTFE membrane and is in direct contact with electrolyte 18, based on potassium hydroxide, within an electrolyte chamber. A lead anode 20 is located within the electrolyte chamber, in direct contact with the electrolyte. A load resistor 22 completes a circuit between the anode and cathode. The electrolyte chamber, mass flow control member, gas space, hydrophobic PTFE membrane, cathode, anode, electrolyte and circuitry function as an electrochemical oxygen sensor.

In use, fuel gas diffuses through the inlet into the potassium permanganate filled chamber. A range of gaseous species including nitrogen and oxygen, including nitrogen dioxide, is removed from the received gas by the potassium permanganate.

The substantial majority of the nitrogen dioxide is removed before the received gas reaches the capillary. The scrubbed gas diffuses through the capillary, gas space and PTFE membrane where oxygen is reduced by the cathode. Simultaneously, lead is oxidized to lead oxide at the anode and the resulting current is measured.

Essentially all of the oxygen which diffuses through the capillary is reduced and so, as with conventional mass transport limited electrochemical oxygen sensors, the output current depends on the rate of diffusion of oxygen through the capillary. In contrast to partial pressure electrochemical oxygen sensors, the output current depends on the oxygen concentration of gas received by the sensor rather than the partial pressure of oxygen outside the sensor.

We have found that, by providing nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor, the lifetime of the fuel gas analyzer is restored to normal, or near normal, when measuring the concentration of oxygen in fuel gases which comprise nitrogen dioxide and which are saturated, or nearly saturated with water vapor.

Experimental Results

Eight electrochemical gas sensors were used to measure oxygen in atmospheric air, with the addition of 1,000 ppm nitrogen dioxide and water vapor to 90% relative humidity. All experiments were carried out at room temperature and pressure. Oxygen concentration was 20.9%. The electrochemical gas sensors used in all of the experiment were O2-A2 oxygen sensors from Alphasense Limited of Great Dunmow, UK, but similar results would be anticipated with comparable sensors from other suppliers. The oxygen sensor broadly corresponded to the apparatus described above and illustrated with reference to FIG. 1, except that there was no nitrogen-containing-gas removing means. The sensors include a cathode comprising platinum, graphite and binder particles, a lead anode, a hydrophobic PTFE membrane covering and supporting the cathode and a mass flow control member comprising a capillary extending through a block of ABS.

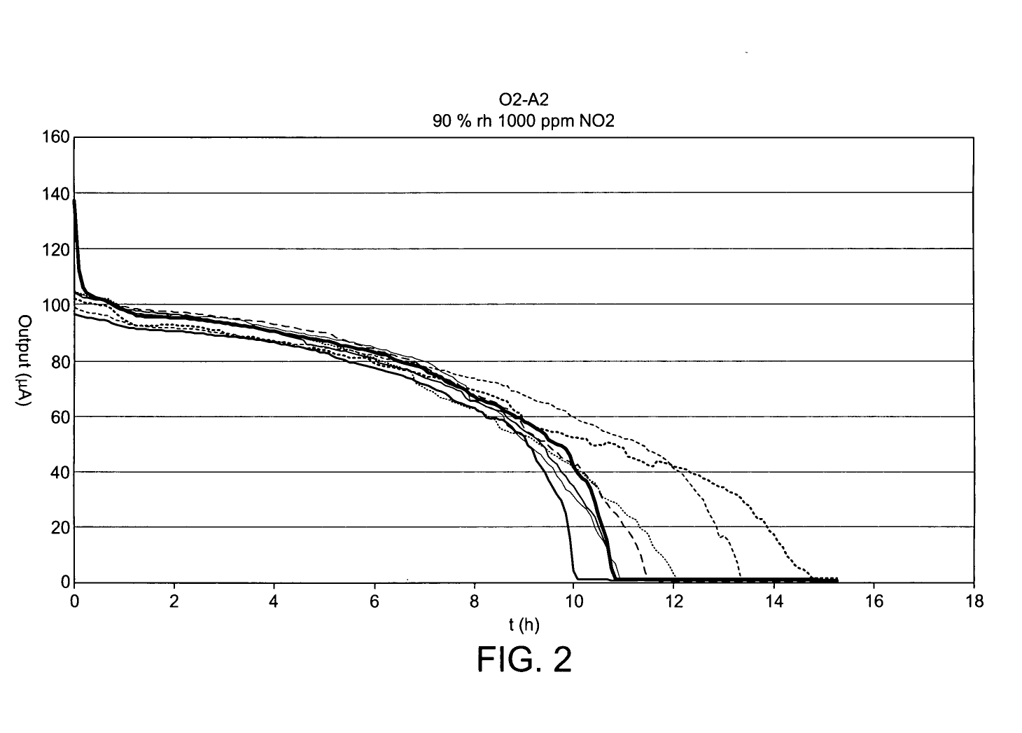

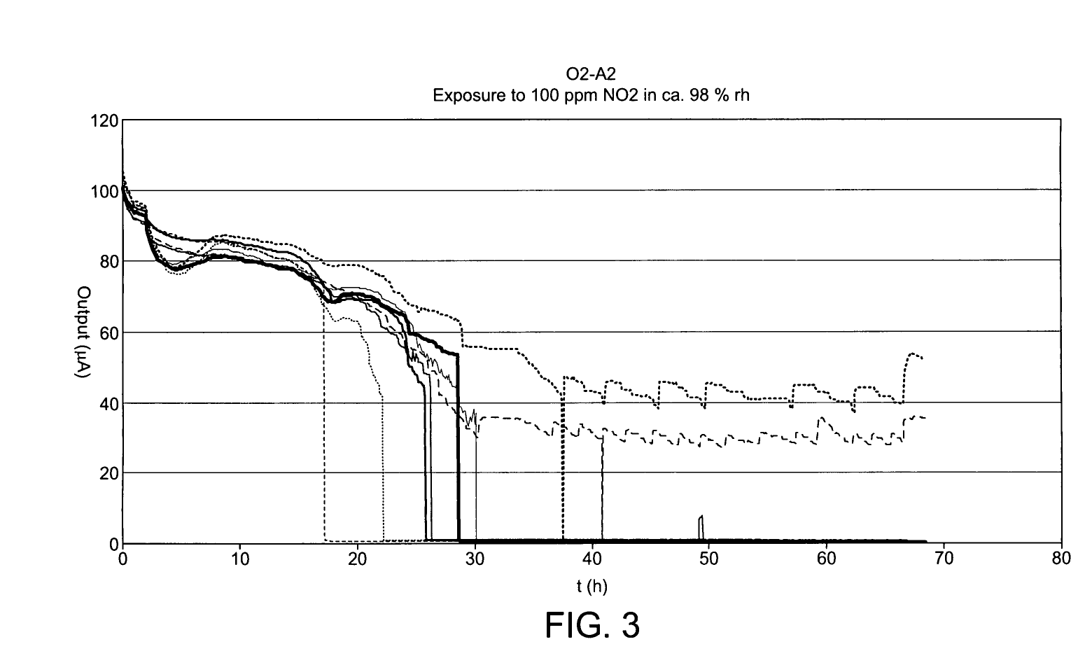

FIG. 2 is a graph of the output current with time from the eight sensors. Although the O2-A2 sensors have a two year working life, the sensors failed catastrophically after 10 to 15 hours. FIG. 3 is a graph of output current during an experiment with conditions which correspond to the previous experiments except that the nitrogen dioxide concentration was 100 ppm and the relative humidity was 98%. In this case, 6 of the 8 sensors failed in 18 to 41 hours.

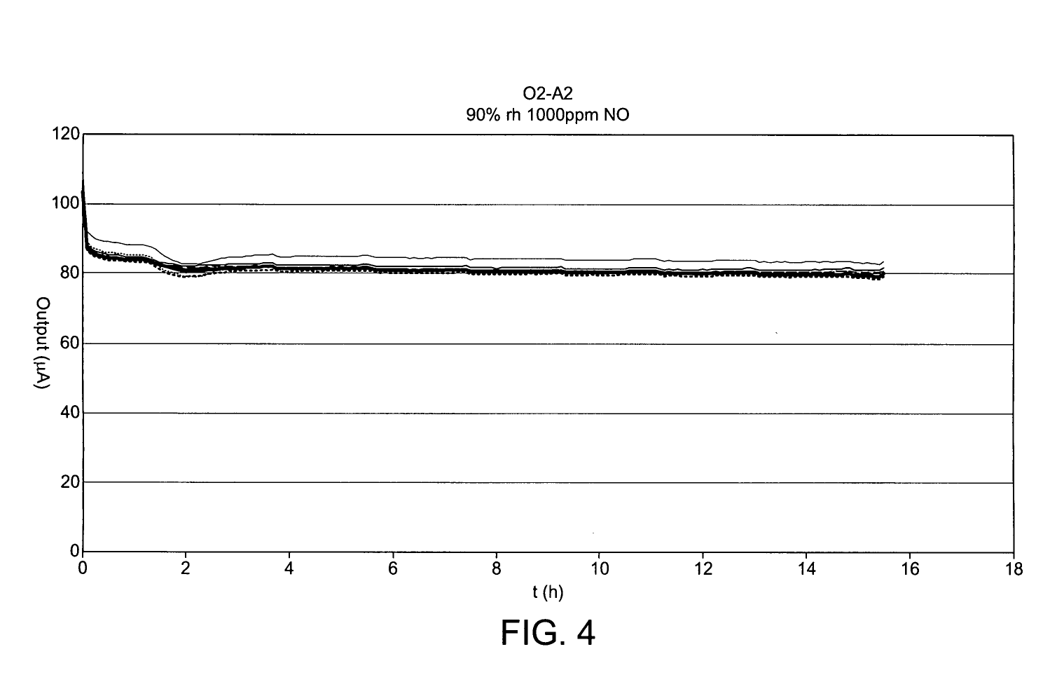

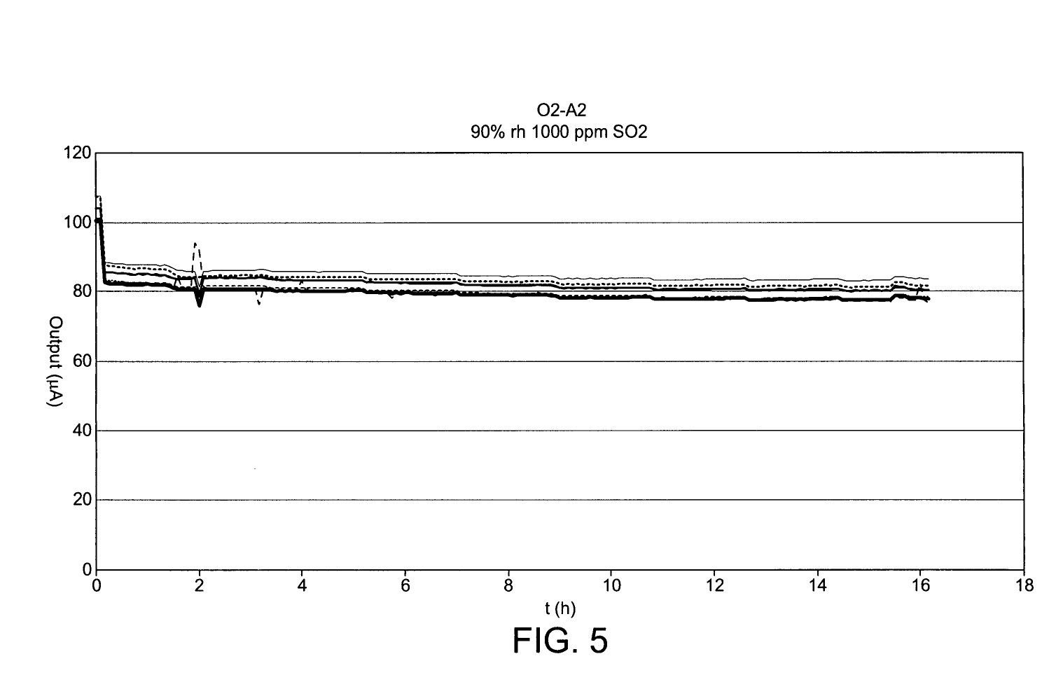

Corresponding experiments were conducted at 90% humidity and room temperature and pressure using 1,000 ppm of nitric oxide or 1,000 sulfur dioxide instead of nitrogen dioxide. The results of these experiments, illustrated in FIGS. 4 and 5 respectively demonstrate that this effect arises in humid air specifically due to nitrogen dioxide. In these experiments, the decline in output current in the first minutes of the experiment is caused by dilution of oxygen by nitrogen from the gas bottles which supplied the nitric oxide and sulfur dioxide.

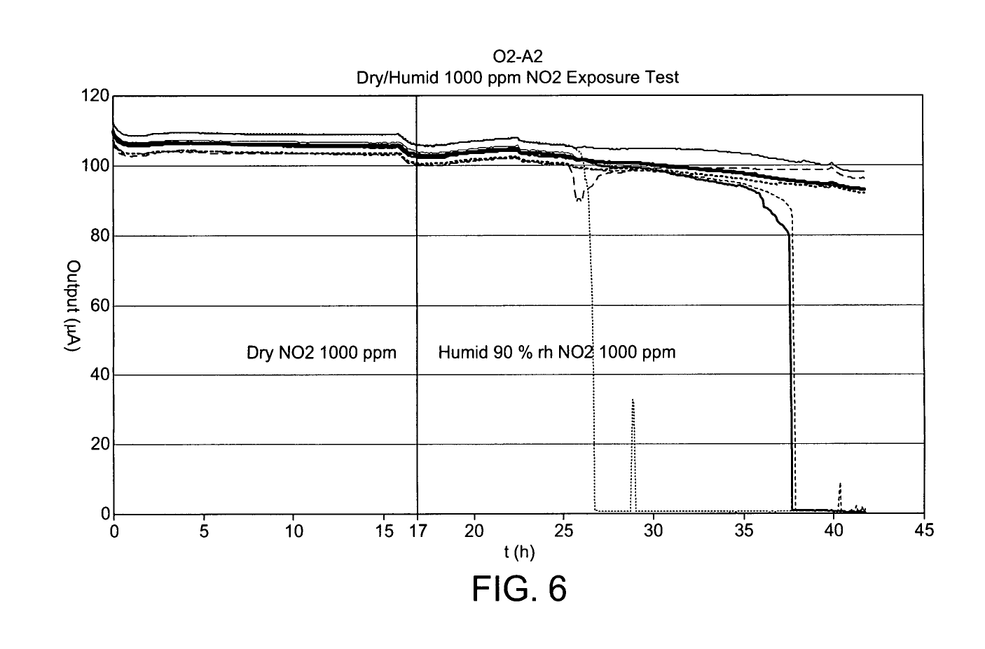

FIG. 6 illustrates an experiment in which eight oxygen sensors were exposed to dry atmospheric air including 1,000 ppm nitrogen dioxide for 17 hours, followed by atmospheric air including 1,000 ppm nitrogen dioxide at a relative humidity of 90%, at room temperature and pressure throughout. The results of the experiment demonstrate that the sensors were not affected by 1,000 ppm nitrogen dioxide, but that they were damaged in the presence of both nitrogen dioxide and a relatively high concentration of water vapor.

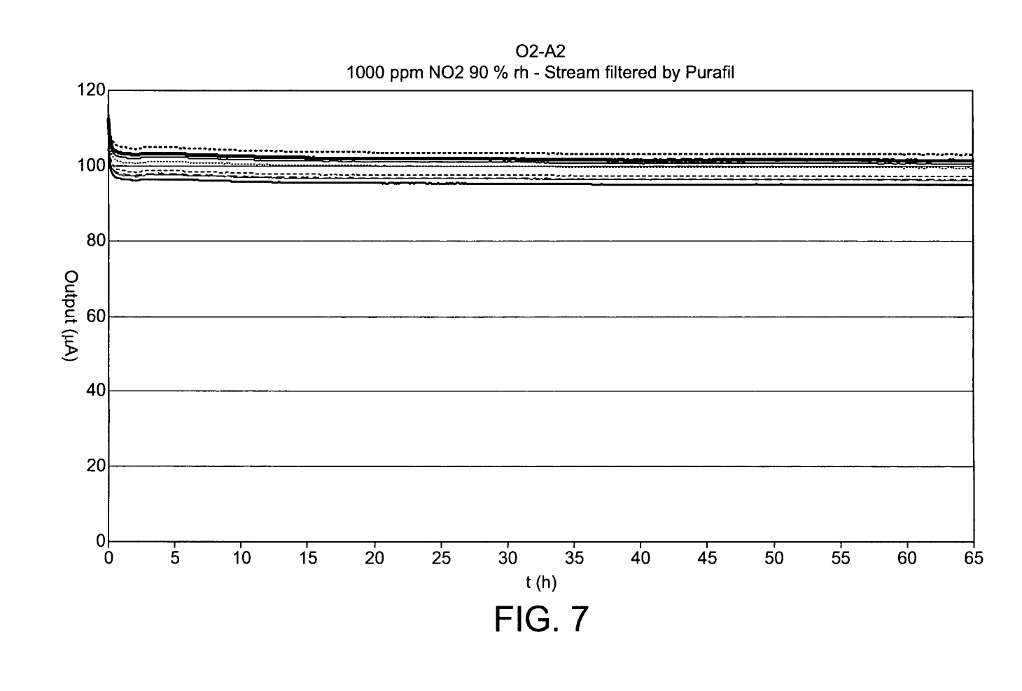

FIG. 7 illustrates the results of an experiment in which the output current from eight oxygen sensors was monitored in the presence of gas comprising atmospheric air to which had been introduced 1,000 ppm nitrogen dioxide and water vapor to give a relative humidity of 95% which was continuously filtered through a Purafil brand filter from Purafil, Inc. of Doraville, USA. (Purafil is a trade mark), The Purafil brand filter includes potassium permanganate and is operable to chemisorb nitrogen dioxide, thereby functioning as the nitrogen-containing-gas removing means. As is apparent from FIG. 7, the inclusion of the filter enabled the oxygen sensors to perform as normal.

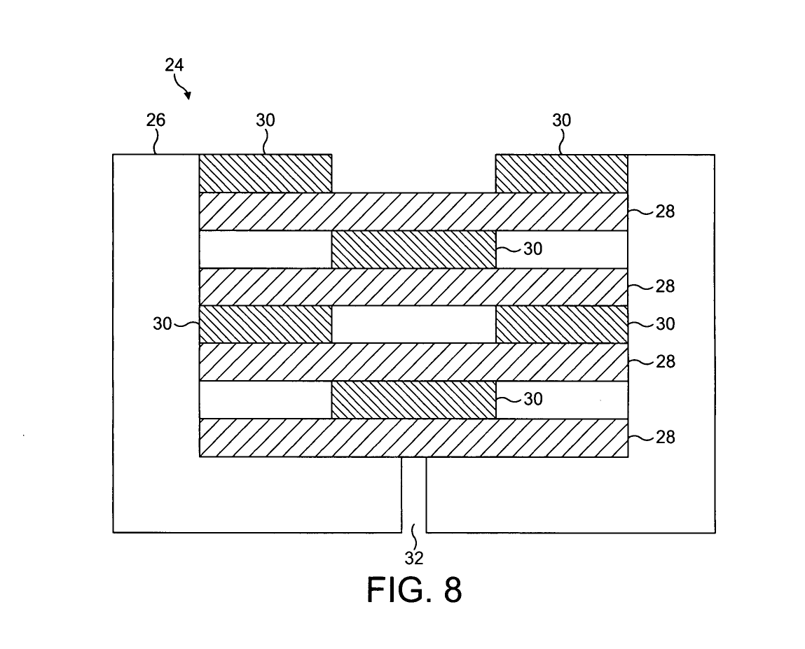

FIG. 8 illustrates an alternative filter 24 comprising a filter housing 26 which replaces inlet 4 and potassium permanganate filled chamber 6 of the apparatus illustrated in FIG. 1 to filter received gas before it reaches the capillary tube 10. The filter housing employs four sheets of activated carbon cloth 28 (type 150SL, available from Calgon Carbon Corporation of Pittsburgh, USA). The activated carbon cloth is arranged in layers spaced apart by intermediate gas-impermeable polymer spacers 30 which are configured to create a tortuous path for gas to diffuse through the sensor. For example, where the sensor is generally cylindrical, the gas-impermeable polymer members can be alternatively annular (having a central hole) and circular members which do not overlap significantly so that gas must diffuse alternately radially outwards and radially inwards in order to pass through the filter. The provision of a tortuous gas diffusion pathway maximizes the surface area of carbon which is available to adsorb nitrogen dioxide from the received gas and increases the residence time of received gas within the filter. The configuration of the gas diffusion pathway and the internal surface area of the activated carbon cloth have been selected so that the filter adsorbs substantially all of the received nitrogen dioxide. A passage 32 forms an outlet to the filter housing which communicates with the capillary tube. The passage 32 is much broader than the capillary tube so that it is not diffusion limiting. For example, the passage may have a diameter of around 2 mm.

Discussion

We have demonstrated that electrochemical oxygen sensors are degraded in the presence of even a low concentration of nitrogen dioxide, in air which is saturated, or nearly saturated, with water vapor and demonstrated that this degradation can be prevented using nitrogen-containing-gas removing means (such as a gas removing filter) which removes from received gas one or more gaseous species including nitrogen and oxygen, which is either nitrogen dioxide or formed from nitrogen dioxide in the presence of sufficient water vapor, which would otherwise lead to damage of the electrochemical oxygen sensor. Alternatively, water vapor removing means, such as a water vapor removing filter, could be employed to remove water vapor from received air. However, as a higher volume of water vapor would need to be removed than gaseous species comprising nitrogen and oxygen, in most circumstances, the use of nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor, is preferred.

A number of different nitric oxides (referred to generally as NOₓ) are found in fuel gas, including nitrogen dioxide (NO₂), nitric oxide (NO), nitrous oxide (N₂O), the nitrate radical (NO₃), nitric acid (HNO₃), nitrous acid (HNO₂) and dinitrogen pentoxide (N₂O₅). Nitric oxides are formed by a number of different routes. Thermal NOₓ are formed at high temperatures (>1,600° C.), where molecular oxygen and nitrogen disassociate into their atomic states. Fuel NOₓ results from the combustion of fossil fuels, such as coal, gas and oil, and biofuels, such as wood, where nitrogen contained within the fuel is released as a free radical which forms nitric oxide. Fuel NOₓ forms up to 50% of NOₓ when combusting oil and 80% of NOₓ when combusting coal.

In boilers, the majority of NOₓ is in the form of nitric oxide. However, there are a number of different mechanisms by which nitric oxide can be converted to nitrogen dioxide. Nitrogen dioxide is generated by the reaction between nitric oxide and certain hydrocarbons, such as ethylene, at low temperatures; nitrogen dioxide is generated by the reaction between nitric oxide and peroxy radicals or HO₂; nitrogen dioxide is rapidly generated by the reaction between nitric oxide and ozone. Nitrogen dioxide is also generated by the reaction between nitric oxide and oxygen. The rate of this reaction is generally slow, but it can be accelerated by water, particulates (giving heterogenous catalytic sites) and some others materials which could be found inside boilers.

We suggest a possible mechanism by which the presence of nitrogen dioxide could lead to electrochemical oxygen sensors being damaged only in very humid conditions. The nitrate radical is formed rapidly from the reaction between ozone and nitrogen dioxide. Ozone can be formed from the reaction between nitrogen dioxide and oxygen. Nitrogen dioxide and the nitrate radical react to form dinitrogen pentoxide, which is very soluble in water. In a humid environment, almost all nitrate radicals will be converted to dinitrogen pentoxide. Dinitrogen pentoxide is known to be converted to nitric acid when dissolved in water droplets. Accordingly, concentrated nitric acid may be formed from nitrogen dioxide in very humid conditions, for example the conditions found in condensing boilers. In this case, the provision of means to remove one or more of nitrogen dioxide, dinitrogen pentoxide or nitric acid gas and/or water vapor removing means could prevent damage to electrochemical oxygen sensors in which the mass flow control member or gas permeable liquid impermeable barrier is made from a material (typically a plastics material) which is damaged in the presence of nitrogen dioxide and a sufficient concentration of water vapor, perhaps due to the formation of nitric acid.

In very humid air containing nitrogen dioxide, mass flow control members made from plastics materials, such as ABS or polycarbonate, could be damaged. This damage could be prevented by providing the nitrogen-containing-gas removing means and/or or water vapor removing means, upstream of the mass flow control member, or within the mass flow control member, for example within the capillary. In very humid air containing nitrogen dioxide, gas permeable liquid impermeable barriers made from plastics materials, such as PTFE, could be damaged, for example their surface energy might change enabling electrolyte to penetrate the barrier, causing the gas space to be flooded. This damage could be prevented by providing nitrogen-containing-gas removing means and/or water removing means upstream of the gas permeable liquid impermeable barrier, for example, before the mass flow control member, within the mass flow control member, or within the gas space between the mass flow control member and the gas permeable liquid impermeable barrier.

Further modifications and variations may be made within the scope of the invention herein disclosed.

What is claimed is:

1. A fuel gas analyzer for measuring the concentration of oxygen in fuel gas, comprising an inlet for receiving gas for analysis, an electrochemical oxygen sensor, and water vapor removing means for reducing the relative humidity of received gas and/or nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor.

2. A fuel gas analyzer according to claim 1, comprising nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor.

3. A fuel gas analyzer according to claim 2, wherein the nitrogen-containing-gas removing means is nitric acid removing means for removing nitric acid from received gas.

4. A fuel gas analyzer according to claim 2, wherein nitrogen-containing-gas removing means is nitrous acid removing means for removing nitrous acid from received gas.

5. A fuel gas analyzer according to claim 2, wherein the nitrogen-containing-gas removing means is dinitrogen pentoxide removing means for removing nitrogen pentoxide from received gas.

6. A fuel gas analyzer according to claim 2, wherein the nitrogen-containing-gas removing means is nitrogen dioxide removing means for removing nitrogen dioxide from received gas.

7. A fuel gas analyzer according to claim 2, wherein the nitrogen-containing-gas removing means is operable to remove a range of acid-forming gases including nitrogen monoxide, nitrogen dioxide and sulphur dioxide from received gas.

8. A fuel gas analyzer according to claim 2, wherein the nitrogen-containing-gas removing means is a nitrogen-containing-gas removing filter.

9. A fuel gas analyzer according to claim 8, wherein the filter comprises a permanganate salt.

10. A fuel gas analyzer according to claim 2, wherein the nitrogen-containing-gas removing means changes visual properties and thereby provides a visual indicator when the nitrogen-containing-gas removing means is coming towards the end of its operational life.

11. A fuel gas analyzer according to claim 1, comprising water vapor removing means for removing water vapor from received gas.

12. A fuel gas analyzer according to claim 1, wherein the electrochemical oxygen sensor is a mass flow controlled electrochemical oxygen sensor comprising a mass flow control member.

13. A fuel gas analyzer according to claim 12, wherein the mass flow control member is made from a plastics material.

14. A fuel gas analyzer according to claim 12, wherein the nitrogen-containing-gas removing means and/or water vapor removing means are provided within the mass flow control member.

15. A fuel gas analyzer according to claim 12, wherein the nitrogen-containing-gas removing means and/or water vapor removing means are provided within the mass flow control member.

16. A fuel gas analyzer according to claim 12, wherein the nitrogen-containing-gas removing means and/or water vapor removing means are provided intermediate the inlet and the mass flow control member.

17. A fuel gas analyzer according to claim 12, comprising a cathode and a gas permeable liquid impermeable barrier intermediate the cathode and a gas space, the gas space being intermediate the gas permeable liquid impermeable barrier and the mass flow control member, wherein the nitrogen-containing-gas removing means and/or water vapor removing means are provided within the gas space.

18. A fuel gas analyzer according to claim 2, further comprising a nitrogen oxide sensor which is operable to measure nitrogen dioxide, wherein the nitrogen oxide sensor is located intermediate the inlet and the nitrogen-containing-gas removing means or in gaseous communication with the inlet other than through the nitrogen-containing-gas removing means.

19. A fuel in gaseous communication with a fuel gas analyzer according to claim 1.

20. A fuel according to claim 19, which conducts fuel gas which, were it not for the presence of the nitrogen-containing-gas removing means and/or water vapor removing means, would cause the fuel gas analyzer to be damaged.

21. A fuel according to claim 19, wherein the nitrogen-containing-gas removing means and/or water vapor removing means are integrated with the electrochemical oxygen sensor.

22. A condensing boiler including a fuel according to claim 19.

23. A method of measuring the concentration of oxygen in a fuel gas, comprising the use of a fuel gas analyzer according to claim 1, wherein use of said fuel gas analyzer without the presence of the nitrogen-containing-gas removing means and/or water vapor removing means, would cause the fuel gas analyzer to be damaged.

24. A method of measuring the concentration of oxygen in a fuel gas according to claim 23, wherein the fuel gas comprises water vapor with a relative humidity of at least 80% and nitrogen dioxide at a concentration of at least 5 ppm.

25. A method of measuring the concentration of oxygen in a received fuel gas comprising nitrogen dioxide and water vapor using an electrochemical oxygen sensor, comprising providing, intermediate an inlet from which the received fuel gas is received and a component of the electrochemical oxygen sensor which can be damaged in the presence of nitrogen dioxide and sufficient water vapor, water vapor removing means for reducing the relative humidity of received gas and/or nitrogen-containing-gas removing means for removing from received gas one or more gaseous species comprising nitrogen and oxygen which are either nitrogen dioxide, or formed from nitrogen dioxide in the presence of sufficient water vapor, which would damage the component of the electrochemical oxygen sensor if they were not removed.

26. A method according to claim 25, wherein the received fuel gas has a relative humidity of at least 80%.

27. A method of developing a fuel gas analyzer which has an improved operational lifetime in the presence of nitrogen dioxide and water vapor with a relative humidity of at least 80%, comprising comparing the operational lifetime of a fuel gas analyzer including water vapor removing means for reducing the relative humidity of received gas and/or nitrogen-containing-gas removing means for removing from received gas one or more gaseous species comprising nitrogen and oxygen which are either nitrogen dioxide, or formed from nitrogen dioxide in the presence of sufficient water vapor, which would otherwise lead to damage of the electrochemical oxygen sensor and a fuel gas analyzer lacking said nitrogen-containing-gas and/or water vapor removing means in a gas sample comprising at least 5 ppm of nitrogen dioxide and having a relative humidity of at least 80%.

28. A method of developing a fuel gas analyzer which has an improved operational lifetime in the presence of nitrogen dioxide and a high concentration of water vapor comprising comparing the operational lifetime of a first fuel gas analyzer and a second fuel gas analyzer including at least one part which is made from a different material to a corresponding part in the first fuel gas analyzer in the presence of gas samples comprising at least 5 ppm of nitrogen dioxide and having a relative humidity of at least 80%.

29. A method of monitoring the concentration of oxygen in a fuel comprising measuring the relative humidity of gas within the fuel and, if the relative humidity exceeds a predetermined amount bringing a fuel gas analyzer according to claim 1 into gaseous communication with the gas within the fuel to monitor the concentration of oxygen within the fuel.

30. A method of monitoring the concentration of oxygen in a fuel comprising measuring the relative humidity of gas within the fuel and the concentration of nitrogen dioxide in the gas within the fuel and, if the relative humidity exceeds a predetermined amount and the concentration of nitrogen dioxide exceeds a predetermined amount, bringing a fuel gas analyzer according to claim 1 into gaseous communication with gas within the fuel to monitor the concentration of oxygen within the fuel.
